(19) United States
(12) Patent Application Publication
(10) Pub. No.: US 2022/0078289 A1
(43) Pub. Date: Mar. 10, 2022

(54) METHOD AND DEVICE FOR HANDLING SUBSCRIPTION TO A SERVICE IN A COMMUNICATIONS NETWORK

(71) Applicant: Telefonaktiebolaget LM Ericsson (publ), Stockholm (SE)

(72) Inventors: Senthil Kumar KARUPANAN SUBRAMANIAN, Chennai (IN); Ann Soniya JOHNY, Chennai (IN); N Dilip KUMAR, Chennai (IN); Srinivasa Babu MEDANKI, Guntur (IN); Srivatsan MURALIDHARAN, Chennai (IN); Mohandas P, Chennai (IN); Vanidha R, Chennai (IN); Divya SUNDAR, Chennai (IN)

(21) Appl. No.: 17/419,425

(22) PCT Filed: Jan. 3, 2019
(86) PCT No.: PCT/IN2019/050004

§ 371 Date: Jun. 29, 2021

(51) Int. Cl. H04M 15/00; H04W 4/24; H04W 8/18; H04W 68/00

(52) U.S. Cl. CPC H04M 15/856; H04M 15/58; H04M 15/61; H04W 68/005; H04W 4/24; H04W 8/18; H04M 15/70

(57) ABSTRACT

A method performed by a network node for handling a subscription to service in a communications network is provided. The network node detects that a subscriber's subscription has been deactivated from the communications network. The network node obtains data related to usage of the service and analyzes the data to determine one or more contacts of the subscriber that should be notified about the deactivated subscription. The network node initiates one or more notifications to the determined one or more contacts about the deactivated subscription.

### TECHNICAL FIELD

Embodiments herein relate generally to a network node and a method performed by the network node. More particularly the embodiments herein relate to handling a subscription to a service in a communications network.

### BACKGROUND

A subscriber may have one, two or multiple subscriptions to a communications network, i.e. subscriptions to services provided by the service provider of the communications network. Each subscription is identified with a unique subscription identity. The Mobile Station International Integrated Services Digital Network (ISDN) Number (MSISDN) is an example of such unique subscription identity. The subscription identity may also be referred to as a phone number or a mobile number.

A customer management system is a system which handles subscriptions, billing, accounts etc. in relation to services provided the service provider in his communications system. FIG. 1 shows an example of a customer management system 100. The customer management system 100 handles customer care and billing. It offers an object-oriented component-based architecture which allows the system 100 to be easily customized. With the customer management system 100, service providers can easily and quickly adapt the software to their existing business processes, increasing productivity and reducing costs. The customer management system 100 comprises an Account Finder (AF) adapter 101, a Multi Activation (MA) adapter 103 and an Account Information and Refil (AIR) adapter 105. The AF adapter 101 is adapted to be connected to an AF 108 and may send a subscription disconnection output file to the AF 108. The MA adapter 103 is adapted to be connected to a MA 110, and it may send the subscription disconnection output file to the MA 110. The AIR adapted 105 is adapted to be connected to an AIR 113. A Service Delivery Platform (SDP) 115 is adapted to be connected to a batch execution engine 115. The SDP 115 may send a SDP-Charging Data Record (CDR) to the batch execution engine 115. The batch execution engine 115 is adapted to be connected to the customer management system 100 and a billing database 120. The billing database 120 may be a Home Subscribe Server (HSS), a Home Location Register (HLR) or any other suitable database. The billing database 120 may comprise data related to billing, home subscriber usage data, i.e. call records.

In a charging system, multiple SDPs 115 may be used to balance load segmentation of customer data over several SDPs 115. The charging system may be different from the billing system. The charging system and the billing system may be standalone systems or they may be co-located. When contract data has to be retrieved from the SDP 115 or contract data has to be provided to the SDP 115, the corresponding request is addressed to one of the AIRs 113. In order to execute the request, the AIR 113 has to find the ID of the SDP instance where the contract is handled. To enable this, the AF 108 has been implemented as a DNS service that runs on an AIR network element. The AF's 108 main function is to supply the AIRs 113 with the IDs for SDP 115. The AF 108 can map a single MSISDNs or MSISDN ranges to SDP identifiers. It stores the SDP per MSISDN where the respective contract is located to allow the AIR 115 and CCN to look up the SDP 115 for a given MSISDN.

For the maintenance and retrieval of subscriptions in the charging system, some data has to be provided to or obtained from the charging system network elements instead of storing the data in the customer management system 100. The customer management system 100 is responsible for data distribution. For the process of providing and obtaining data from and to the billing database 120, the MA adapter 103, is comprised in the customer management system 100. The MA adapter 103 is responsible for the communication and connection to Multi Activation interface or CA/3G interface.

An orchestration layer of the customer management system 100 provides the distribution of the data to the MA adapter 103. In case data has provided to the billing database 120, the appropriate business action is triggered in the customer management system 100 which is forwarded to the orchestration layer. The orchestration layer again calls an appropriate action of the MA adapter 103. Finally, the MA adapter 103 distributes the data to MA 110 and the billing database 120. Response data from the billing database 120 and the MA 110 is forwarded from the MA 110 through the MA adapter 103 and the orchestration layer to the business logic layer. In case data has to be read from the MA 110 and the billing database 120 for display purposes only, the business logic layer directly triggers an appropriate action of the MA adapter 103.

In the charging system, account data are stored on and obtained from the SDP 115 using the AIR 113 element. For this reason, all requests for account information and any changes to accounts that originate from the customer management system 100 must go through the AIR 113. The AIR adapter 105 provides a mapping interface between the customer management system 100 and the AIR 113 element.

Business actions in the customer management system 100, for example the creation of a new contract or a request for contract information, are mapped to AIR services. Entities in the customer management system 100, for example contract identifiers, are mapped to entities required by the AIR 113 services. Data, for example monetary amount values, is mapped to the required format. If business actions are being executed as part of a batch, the actions can be executed in parallel. In this case, the customer management system 100 and the AIR adapter 105 work in several threads, with each thread having its own connection to the AIR application.

The AF 108 is a Domain Name Server (DNS) service that runs on an AIR 113 element. The AF's 108 main function is to supply the AIR 113 with the IDs for the SDP 115. The AF 108 can map a single MSISDNs or MSISDN ranges to SDP identifiers. The AF 108 stores the SDP 115 per MSISDN where the respective contract is located to allow the AIR 113 and the CCN to look up the SDP 115 for a given MSISDN.

The MA 110 may be referred to as an MA interface or a CA/3G interface and is adapted to provide and obtain data from the billing database 120.

In the charging system, account data are stored on and obtained from the SDP 115 using the AIR 113 element.

The charging system includes one or more SDPs 115 that performs online rating and balance management for calls and events of prepaid and post-paid contracts, known as subscriptions in the charging system.

The assignment of contracts to the SDP 115 is stored in the AF 108.

The batch execution engine 118 is adapted to carry out batch jobs that are used to change specific contract data of many charging system contracts at the same time and to create pre activated-prepaid charging system contracts. The batch jobs are initiated in Configuration Management (ADMX).

Currently, it is possible for the service provider to reassign the MSIDN of a deactivated subscription identity to a new subscriber as depicted in the MSISDN life cycle diagram in FIG. 2. The method illustrated in FIG. 2 comprises at least one of the following steps, which steps may be performed in any suitable order than described below:

### Step 201

A MSISDN is generated by an operator node. The generated MSISDN may be referred to as a new MSISDN after it has been generated and during the first time it is assigned to a subscriber's subscription.

### Step 202

The generated MSISDN is in a free state. When the MSISDN is in a free state, it is not associated to any subscription.

### Step 203

The MSISDN is assigned to a subscriber's subscription to the communications network.

### Step 204

When the MSISN has been assigned to the subscription, then the MSISDN is in a reserved state. The MSISDN cannot be assigned to other subscriptions when the MSISDN is in the reserved state.

### Step 205

The MSISDN is deactivated.

### Step 206

The MSISDN is in a quarantine period when it has been deactivated. The MSISDN cannot be assigned to another subscription when it is in the quarantine period. The quarantine period may be any suitable period, for example between ½-12 months, between 1-8 months, between 2-6 months, it may be 3 months, 4 months etc.

### Step 207

The MSISDN goes back to the free state after the quarantine period has expired. When it has entered the free state, it can be assigned to another subscription. After the MSISDN has gone back to free state, the MSISDN may be referred to as an old MSISDN. When the MSISDN is again in a free state, it may be reassigned to a subscription again.

When a new subscriber's subscription is assigned with an old MSISDN, the subscriber might get unwanted calls or messages from the existing contacts of the old subscriber. These unwanted communications from the old subscriber's contacts annoy the new subscriber and result in a bad user experience and eventually result in opportunity loss for the service provider.

When the subscription identity gets deactivated and reassigned to another subscriber's subscription, the frequent calls and messages from the close contacts of the previous subscriber might annoy the new subscriber receiving the calls. This might bring down the user experience of the new subscriber who is in danger of churning out from the network.

Reusing the MSISDN is unavoidable which results in the problems described above. Hence it is necessary to handle the problems associated with such number reallocations for better user experience.

Therefore, there is a need to at least mitigate or solve this issue.

### SUMMARY

An objective of embodiments herein is therefore to obviate at least one of the above disadvantages and to provide improved handling of subscriptions to service in a communications network.

According to a first aspect, the object is achieved by a method performed by a network node for handling a subscription to service in a communications network. The network node detects that a subscriber's subscription has been deactivated from the communications network. The network node obtains data related to usage of the service. The network node analyzes the data to determine one or more contacts of the subscriber that should be notified about the deactivated subscription. The network node initiates one or more notifications to the determined one or more contacts about the deactivated subscription.

According to a second aspect, the object is achieved by a network node adapted to detect that a subscriber's subscription to a service has been deactivated from a communications network. The network node is adapted to obtain data related to usage of the service. The network node is adapted to analyze the data to determine one or more contacts of the subscriber that should be notified about the deactivated subscription. The network node is adapted to initiate one or more notifications to the determined one or more contacts about the deactivated subscription.

Thanks to the analysis of the data, contacts of the subscriber can be notified when the subscription has been deactivated, which improves the handling of subscriptions to service in the communications network.

Embodiments herein afford many advantages, of which a non-exhaustive list of examples follows:

An advantage of the embodiments herein is that they provide improved user experience by avoiding unwanted communication from contacts of the old subscriber.

Another advantage of the embodiments herein is that they are easily adaptable with any system and is feasible to implement.

Reusing the subscriber identity is unavoidable. Hence it an advantage of the embodiments herein to improve the reuse of the subscriber identities in order to obtain a better user experience.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1 is a schematic block diagram illustrating a communication system.

FIG. 2 is a flow chart illustrating a method.

FIG. 3 is a schematic block diagram illustrating a system.

FIG. 4 is a signaling diagram illustrating a method.

FIG. 5 is a schematic block diagram illustrating a system.

FIG. 6 is a flow chart illustrating a method.

FIG. 7 is a flow chart illustrating a method.

FIG. 8a illustrates a relationship matrix.

FIG. 8b illustrates a directional graph.

FIG. 9 is a flow chart illustrating a method.

FIG. 10 is a schematic block diagram illustrating a network node.

The drawings are not necessarily to scale and the dimensions of certain features may have been exaggerated for the sake of clarity. Emphasis is instead placed upon illustrating the principle of the embodiments herein.

### DETAILED DESCRIPTION

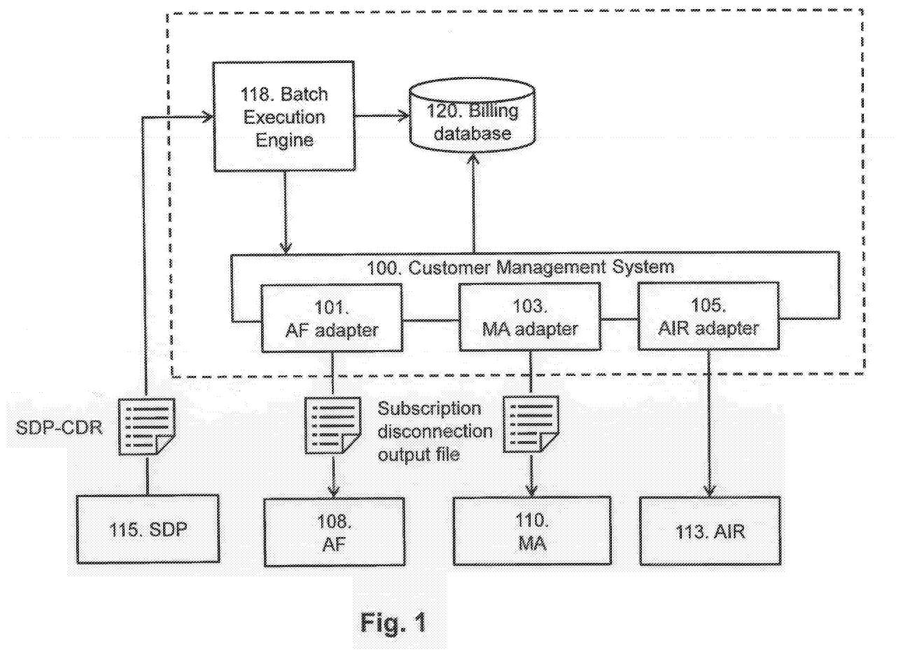

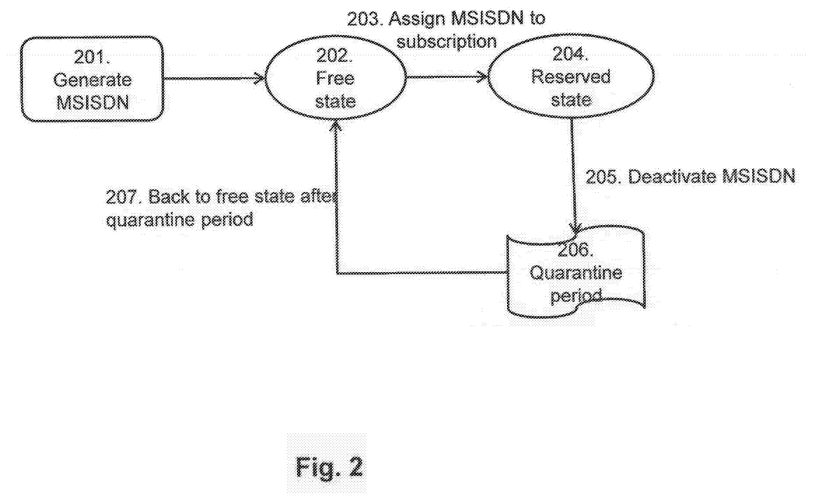

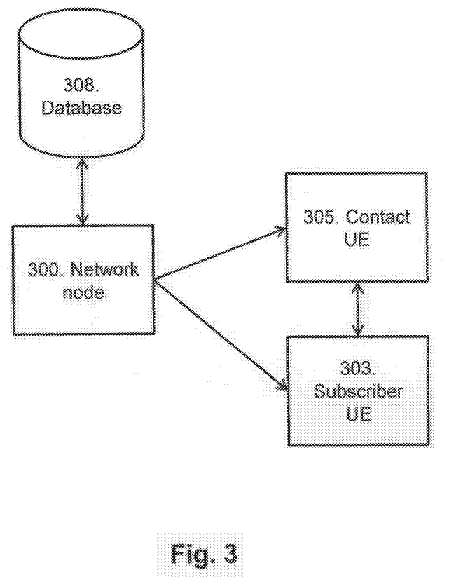

FIG. 3 is a schematic block diagram illustrating a network node 300. The network node 300 may be comprised in the customer management system 100 exemplified in FIG. 1. The network node 300 may be a Subscriber Deactivation Handler (SDH) or any other suitable network node adapted to handle subscriptions.

FIG. 3 further illustrates that the network node 300 is adapted to be connected to one or more subscriber User Equipments (UE) 303. Only one subscriber UE 303 is exemplified in FIG. 3 for the sake of simplicity. The subscriber may have one or more subscriptions to services in the communication system. A subscription is uniquely identified with a subscription ID. The subscriber's subscription to services may be accessible from the one or more subscriber UEs 303. The subscriber UE 303 may also be referred to as a first UE 303.

FIG. 3 illustrates that the network node 300 is adapted to be connected to one or more contact UEs 305. The one or more subscriber UEs 303 and the one or more contact UEs 305 are adapted to communicate with each other. The contact UE 305 may also be referred to as a second UE 305. The one or more contact UEs 301 are associated with one or more contacts of the subscriber using the one or more subscriber UEs 303. In other words, the subscriber and the contacts may communicate with each other via their subscriber UEs 303 and contact UEs 305. The communication may be in the form of voice call, video call, SMS, MMS etc.

A UE, e.g. a subscriber UE 303 and/or the contact UE 305 may be a device by which a subscriber may access services offered by an operator's network and services outside operator's network to which the operator's radio access network and core network provide access, e.g. access to the Internet. The UE may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE may be portable, pocket storable, hand held, computer comprised, or vehicle mounted devices, enabled to communicate voice and/or data, via the radio access network, with another entity, such as another UE or a server.

The network node 300 is adapted to be connected to a database 308. The database 308 may be the billing database 120 exemplified in FIG. 1. The database 308 may be HSS, a HLR or any other suitable database. The database 308 comprises data related to usage of services for a subscriber, billing data, home subscriber usage data, i.e. call records.

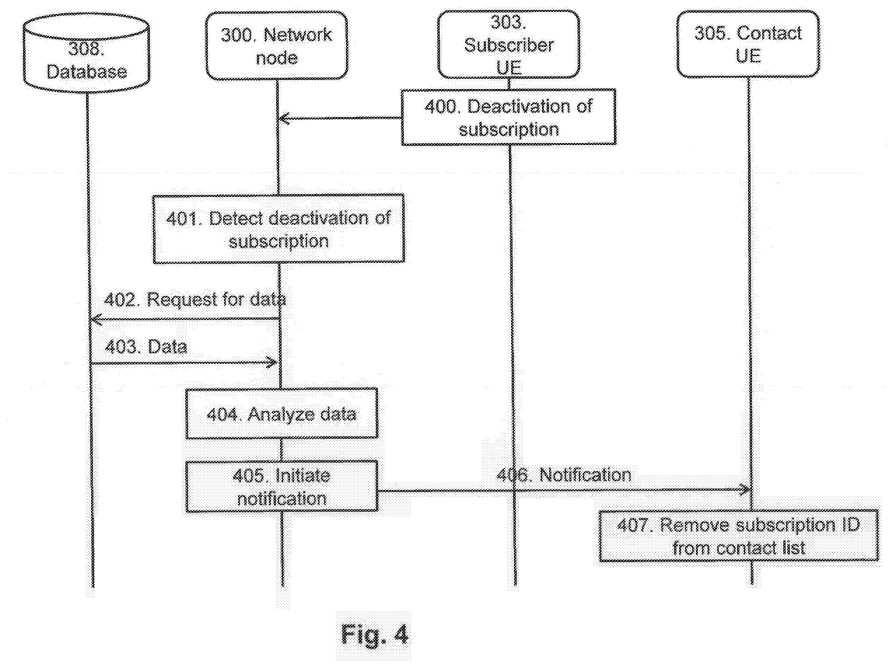

FIG. 4 is a signaling diagram illustrating a method. The method comprises at least one of the following steps, which steps may be performed in any suitable order than described below:

### Step 400

A subscription associated with the subscriber UE 303 is deactivated. This may also be referred to as the subscription identity associated with the subscription is deactivated. The deactivation may be due to that the subscriber has ended the subscription, that the subscriber has not paid the cost for the subscription etc. When the subscription is deactivated, the subscription identity is no longer used by the subscriber. The subscriber UE 303 may notify the network node 300 about the deactivated subscription.

### Step 401

The network node 300 detects the deactivation of the subscription. The network node 300 comprises information about subscriptions that are going to be deactivated. The internal scheduler or e.g. a Batch Execution engine may trigger a new action with a specific code for deactivation. The network node may receive that request and identify the deactivation event.

### Step 402

When the network node 300 has detected the deactivation, it sends, to the database 308, a request for data related to usage of the service which has been used with the subscription. The usage may be associated with the one or more contact UEs 303.

### Step 403

The database 308 sends the requested data to the network node 300. The data may be a list of contacts of the subscriber, i.e. contacts which the subscriber has communicated with using the service provided by the communications network. For example, it may be list of phone numbers, email addresses etc. to contacts of the subscriber.

### Step 404

The network node 300 analyzes the data from the database 308 and determines one or more contacts that should be notified about the deactivation.

### Step 405

The network node 300 initiates notification of the deactivated subscription to the determined one or more contacts.

### Step 406

The one or more contacts receive notifications about the deactivated subscription. The notification may be for example a SMS, MMS etc.

### Step 407

The contact UE 303 may remove the subscription identity associated with the deactivated subscription from their contact lists. The contact UE 303 may also send, to the network node 300, a response confirming that the subscription identity has been removed.

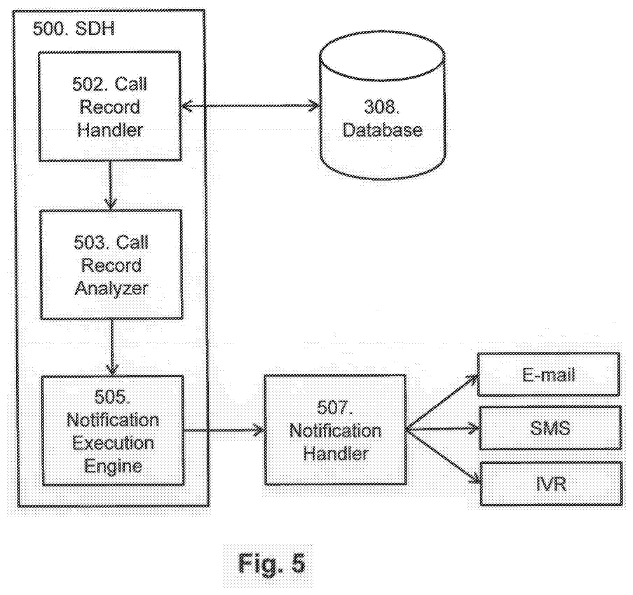

FIG. 5 shows an example where the network node 300 is a Subscriber Deactivation Handler (SDH) 500. The SDH 500 may comprise different entities such as e.g. a Call Record Handler 501, a Call Record Analyzer 503 and a Notification Execution Engine 505. The SDH 500 is adapted to be connected to and to communicate with a Notification handler 507. The Notification handler 507 may be adapted to and to communicate with the Notification Execution Engine 505 of the SDH 500. The notification handler 507 may be adapted to output email, Short Message Service (SMS), Interactive Voice Response (IVR) etc. or any other suitable notifications to a user. The SDH 500 is adapted to be connected to and to communicate with the database 308. The database 308 may also be referred to as a billing database or a billing system database. It may be the Call Record Handler 501 of the SDH 500 that is adapted to be connected to and to communicate with the billing system 510. The entities shown to be comprised in the SDH 500 may be seen as standalone entities comprised in the SDH 500 or they may be seen as functions executed by the SDH 500. For example, the SDH 500 may be adapted to perform call record handling, call record analyzing and notifying.

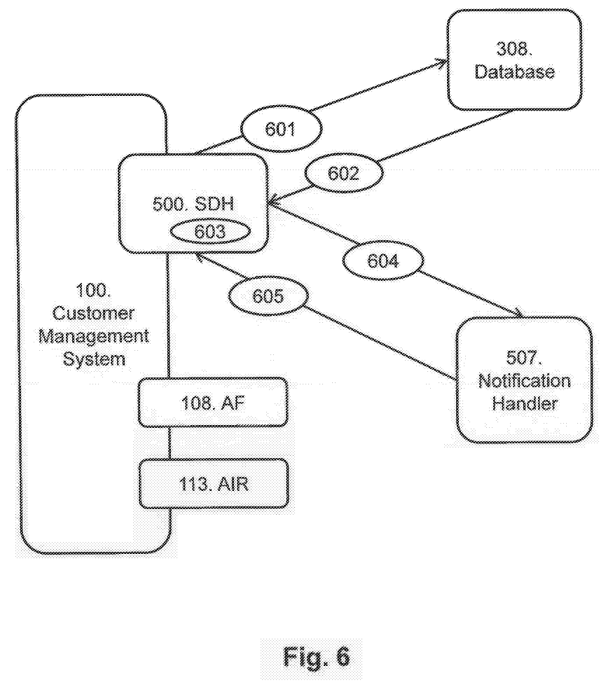

The SDH 500 is adapted to notify the frequent contact list in their preferred notification channel when the subscription identity is deactivated from the communications network. Some examples of functionalities of the components in the SDH 500 will be provided when describing FIG. 6 below.

FIG. 6 shows an example of the architecture of a system in which the embodiments herein may be implemented. FIG. 6 shows the customer management system 100 which comprises the AF 108 and the AIR 113. The customer management system 100 also comprises the SDH 500. Thus, the SDH 500 is comprised in the customer management system 100. The SDH 500 is adapted to be connected to the database 308 and to the notification handler 507, as previously described.

Some functionalities of the SDH 500 are given below and described in the form of a method performed by the SDH 500:

### Steps 601

When the subscription identity deactivation event has been sent to the SDH 500, the SDH 500 may request information about past periods, e.g. 3 months, subscriber Call Detail Records (CDR) from the database 308. The past period may be configurable. It may be the he Call Record Handler 501 that requests the past periods from the database 308.

The Batch Execution Engine 118 may trigger sending of the subscription identify deactivation event based on the subscriber life cycle end date.

### Step 602

The database 308 sends the requested CDR to the SDH 500.

### Step 603

The SDH 500 analyses the CDR in order to determine which contacts of the subscriber that should be notified about the deactivation. The analysis may involve use of a learning model to process the CDRs and creates a directed graph connecting the subscription identity and frequent contacts. It may be the Call Record Analyzer 503 of the SDH 500 that performs step 603.

### Step 604

The SDH 500 invokes the frequent contact list by communicating with an external Notification Handler 507 to notify the subscriber's contacts according to their notification preference. It may be the notification execution engine 505 comprised in the SDH 500 that performs step 604.

### Step 605

The contacts may provide a response to the SDH 500 indicating that they have removed the subscriber identify from their contact lists.

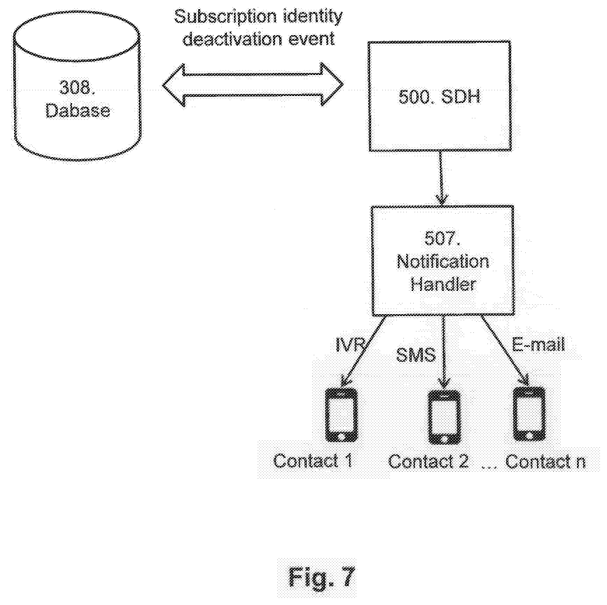

FIG. 7 illustrates another example of when deactivation of a subscriber's subscription identity is notified to his frequent contacts. The database 308 informs the SDH 500 about a Subscription identity deactivation event that has occurred. The SDH 500 performs steps 601-603 as described above, and then it sends instructions to the external notification handler 507 which initiates notification to the subscriber's contacts. The contacts may be notified for example via SMS, email, IVR etc.

The analysis of the data will now be described in more detail. In this example the data is exemplified by a CDR and where the used service is a call. However, the below example is equally applicable to the data in any other suitable format and to any other service type. The following example uses the last 3 months CDR data for the subscriber Ted whose subscription identity is deactivated. Learning models may be used when analyzing the CDR which gives out a relationship matrix for the subscriber. A relationship matrix illustrates the relationship between parameters, i.e. between the contacts and e.g. the frequency of call and elapsed time. The relationship matrix gives the score for the various parameters based on which the subscriber is connected to his close contacts. It may be seen as a correlation between the various parameters which will further lead to a statistical relationship between a subscriber and his contacts. The relationship matrix may further lead to a directional graph which may show the density of the connection between the subscription and his connected contact. The higher the density of the connection, the better it is to choose the contact to be notified.

A directional graph may also be referred to as a weighted directional graph or a digraph. A directional graph is a set of vertices connected by edges. The edges have a direction associated with them. Weights are assigned to the edges in a weighted directional graph. The vertices may be represented by the contacts, and the direction represents the way of communication between the contacts and Ted.

In the example shown below, the density is mapped to a scale of 1-10, where a value of >=5 shows the higher connection with the contact and vice versa.

At least one of the following input parameters may be input to the network node 300 when analyzing the CDR:
Calling Number—The deactivated subscription identity of the subscriber.
Called Number—The number to which the call has been established.
Frequency of call—The frequency of call made from the subscription identity, i.e. a custom field which is arrived based on the number of times the call has been established.
Elapsed time—The duration of the call which is written to the volume field. The cumulative time which is calculated for a close contact who is making the call with the subscription identity.

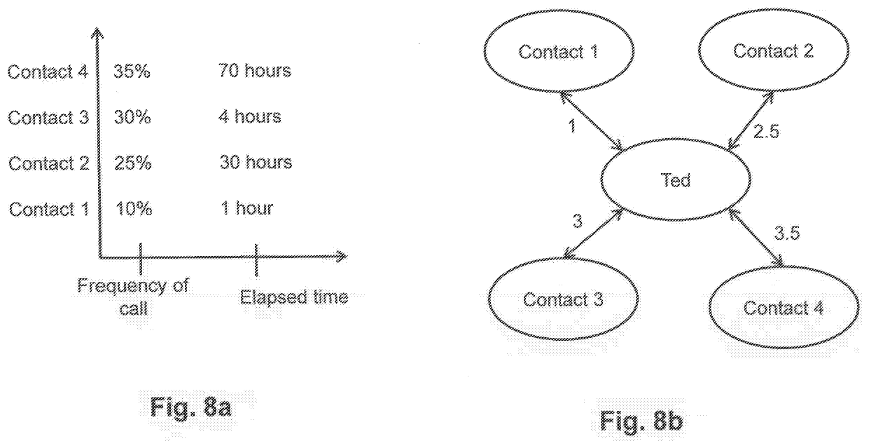

Let's take an example of a subscriber Ted who's MSISDN is 98XXXXXXXX. After analysis of the above four parameters, the frequent contacts of Ted are four subscribers whose relationship matrix is given in FIG. 8a. The relationship matrix in FIG. 8a illustrates the relationship between each contacts with respect to frequency of calls and elapsed time of the calls. The left parameter in the x-axis of FIG. 8a represents the frequency of the call and the right parameter represents the elapsed time. The y-axis represents contact 1, 2, 3 and 4 of Ted. FIG. 8a shows that contact 1 has made 10% of the calls to Ted, contact 2 has made 25% of the calls to Ted, contact 3 has made 30% of the calls to Ted and contact 4 has made 35% of the calls to Ted. FIG. 8a also shows that the calls between Ted and contact 1 has in average an elapsed time of 1 hour, the calls between Ted and contact 2 has in average an elapsed time of 30 hours, the calls between Ted and contact 3 has in average an elapsed time of 4 hours and the calls between Ted and contact 4 has in average an elapsed time of 70 hours. From the relationship matric in FIG. 8a, the directional graph in FIG. 8b can be made. Based on the directional graph in FIG. 8b, contact 2, contact 3 and contact 4 of Ted are chosen for the notifications when the subscriber Ted's MSISDN is deactivated. The numbers 1, 2.5, 3 and 3.5 in FIG. 8 corresponds to the % in the frequency calls in FIG. 8a. These three contacts 2, 3 and 4 are chosen because they have the highest frequency of call and elapsed time, i.e. their frequency of call and elapsed time have reached or exceeded a threshold. Contact 1 is not chosen because his frequency of call and elapsed time is below the threshold. In other words, Ted has not had very many calls to contact 1, and it is therefore determined that it is not necessary to notify contact 1.

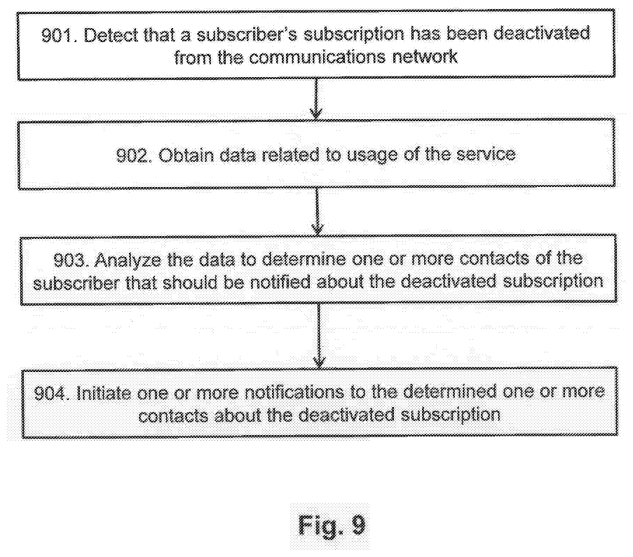

The method described above will now be described seen from the perspective of the network node 300. FIG. 9 is a flowchart describing the present method in the network node 300, for handling a subscription to service in a communications network. A subscription identity may identify the subscription to the service for the subscriber. The subscription identity may be a MSISDN. The network node 300 may be SDH 500 and may be comprised in a customer management system 100. The method comprises at least one of the following steps to be performed by the network node 300, which steps may be performed in any suitable order than described below:

### Step 901

This step corresponds to step 401 in FIG. 4. The network node 300 detects that a subscriber's subscription has been deactivated from the communications network. This may also be described as the network node 300 detects that a subscription identity has been deactivated from the communications network. Deactivated refers to that the subscription to the service has ended, that it has been disabled, that it does not exist anymore etc.

### Step 902

This step corresponds to steps 402 and 403 in FIG. 4 and steps 601 and 602 in FIG. 6. The network node 300 obtains data related to usage of the service. The service may be for example a voice call, a SMS, a MMS, a video call etc. The usage may be usage of the service used by the subscriber which has a subscription to the service.

The obtained data may be associated with a time period. The time period may be for example x number of days prior to the deactivation of the subscription, y number of weeks prior to the deactivation of the subscription, z number of months prior to the deactivation of the subscription etc. x, y and z are any positive integers.

The obtained data may indicate a usage frequency to and/or from contacts. The usage frequency may indicate the frequency of usage of the service which has taken place between the subscriber and his contacts. The frequency may be represented by a % of the used service with each of the contacts.

The obtained data may indicate a usage duration of service usage between the subscription identity and the contacts. The usage duration may indicate the duration of the used service. The usage duration may be an average usage duration of all services which has taken place between the subscriber and each of the contacts. The duration may be for example in seconds, minutes, hours. The usage duration may be in the obtained data when the service is for example a voice call or a video call.

The obtained data may comprise at least one of:
Identity of each contact, and/or
Usage frequency for service usage between the subscriber identity and each contact, and/or
Usage duration for each service usage between the subscriber identity and each contact.

The identity of the contact may be represented by a subscription identity of the contact, e.g. a MSISDN.

The obtained data may be a CDR.
The data may be obtained from a database 308.

### Step 903

This step corresponds to step 404 in FIG. 4 and step 603 in FIG. 6. The network node 300 analyzes the data to determine one or more contacts of the subscriber that should be notified about the deactivated subscription.

The analysis of the data may comprise creating a graph representing a connection between the subscription identity and the contact. The graph may be a directional graph or a weighted directional graph, for example as shown in FIG. 8b.

The graph may show a density of a connection between the subscription identity and the contact.

The determined one or more contacts to be notified may be contacts associated with a usage frequency that is above a frequency threshold. The frequency threshold is related to the frequency of the used service between the subscriber and the contacts.

The determined one or more contacts to be notified may be contacts associated with a usage duration that is above a duration threshold. The duration threshold is related to the duration of the used service between the subscriber and the contacts.

The determined one or more contacts to be notified may be one or more contacts associated with values in the graph that are larger than a graph threshold.

### Step 904

This step corresponds to step 405 in FIG. 4 and step 604 in FIG. 6. The network node 300 initiates one or more notifications to the determined one or more contacts about the deactivated subscription.

The subscription identity may be a MSISDN and may be comprised in the notification to the one or more contacts.

The determined one or more contacts may be notified via SMS, and/or email and/or IVR, or any other suitable notification type.

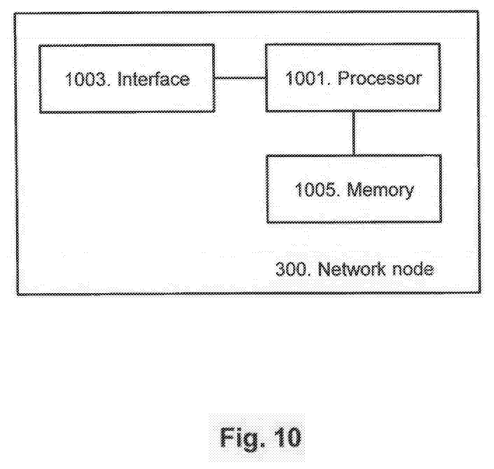

In FIG. 10, there is shown a network node apparatus. The network node 300 comprises a processor 1001, an interface 1003 and a memory 1005, in which memory instructions are stored for carrying out the method steps explained above. The network node 300 communicates via the interface 1003. The interface 1003 comprises both an external interface, communicating with a transmitter and receiver, and internal interfaces (not shown). A subscription identity may identify the subscription of the service for the subscriber. The subscription identity may be a MSISDN. The network node 300 may be a SDH 500 and may be comprised in a Customer Management System 100.

The network node is adapted to, e.g. by means of the processor 1001, detect that a subscriber's subscription to a service has been deactivated from a communications network. The service may be for example a voice call, a SMS, a MMS, a video call etc.

The network node is adapted to, e.g. by means of the interface 1003, obtain data related to usage of the service. The usage may be usage of the service used by the subscriber which has a subscription to the service.

The obtained data may be associated with a time period. The time period may be for example x number of days prior to the deactivation of the subscription, y number of weeks prior to the deactivation of the subscription, z number of months prior to the deactivation of the subscription etc. x, y and z are any positive integers.

The obtained data may indicate a usage frequency to and/or from contacts.

The obtained data may indicate a usage duration of service usage between the subscription identity and the contacts.

The data may be obtained from a database 308.

The obtained data may be a CDR.

The usage may be usage of the service used by the subscriber. The obtained data may comprise at least one of:
Identity of each contact, and/or
Usage frequency for service usage between the subscriber identity and each contact, and/or
Usage duration for each service usage between the subscriber identity and each contact.

The identity of the contact may be represented by a subscription identity of the contact, e.g. a MSISDN.

The network node is adapted to, e.g. by means of the processor 1001, analyze the data to determine one or more contacts of the subscriber that should be notified about the deactivated subscription.

The network node may be adapted to, e.g. by means of the processor 1001, create a graph representing a connection between the subscription identity and the contact. The graph may be a weighted directional graph. The graph may show a density of a connection between the subscription identity and the contact.

The network node is adapted to, e.g. by means of the processor 1001, initiate one or more notifications to the determined one or more contacts about the deactivated subscription. The determined one or more contacts to be notified may be contacts associated with a usage frequency that is above a frequency threshold. The determined one or more contacts to be notified may be contacts associated with a usage duration that is above a duration threshold. The one or more contacts to be notified may be one or more contacts associated with values in the graph that are larger than a graph threshold. The subscription identity may be a MSISDN and may be comprised in the notification to the one or more contacts.

The network node may be adapted to, e.g. by means of the processor 1001, initiate the one or more notifications to the determined one or more contacts via SMS and/or email and/or IVR.

The present mechanism for handling a subscription to service in a communications network may be implemented through one or more processors, such as a processor in the network node 300 together with computer program code for performing the functions of the embodiments herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the embodiments herein when being loaded into the network node 300. One such carrier may be in the form of a CD ROM disc. It is however feasible with other data carriers such as a memory stick. The computer program code can furthermore be provided as pure program code on a server and downloaded to the network node 300.

A computer program may comprising instructions which, when executed on at least one processor, cause the at least one processor to carry out the method described above. A carrier may comprise the computer program, and the carrier may be one of an electronic signal, optical signal, radio signal or computer readable storage medium.

Summarized, the embodiments herein relate to handling of subscription identity deactivation when the deactivation request is being received from the billing system. The frequent contacts of the deactivated subscriber are notified so that they can remove the subscription identity from their own contact list.

Reusing the subscription identity is unavoidable and at the same time, providing a better user experience to the new subscriber which reuses the subscription identity is very critical, and hence it is very important to handle the problems associated with such reused number which is achieved herein.

The embodiments herein are not limited to the above described embodiments. Various alternatives, modifications and equivalents may be used. Therefore, the above embodiments should not be taken as limiting the scope of the embodiments, which is defined by the appended claims. A feature from one embodiment may be combined with one or more features of any other embodiment.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods defined in the appended claims may, without departing from the embodiments herein, be performed in another order than the order in which they appear in the claims.

1. A method performed by a network node for handling a subscription to a service in a communications network, the method comprising:
detecting that a subscriber's subscription has been deactivated from the communications network;
obtaining data related to usage of the service;
analyzing the data to determine one or more contacts of the subscriber that should be notified about the deactivated subscription; and
initiating one or more notifications to the determined one or more contacts about the deactivated subscription.

2. The method according to claim 1, wherein the obtained data is associated with a time period.

3. The method according to claim 1, wherein the obtained data indicates a usage frequency to and/or from contacts, and
wherein the determined one or more contacts to be notified are contacts associated with a usage frequency that is above a frequency threshold.

4. The method according to claim 1, wherein a subscription identity identifies the subscription to the service for the subscriber,
wherein the obtained data indicates a usage duration of service usage between the subscription identity and the contacts, and
wherein the determined one or more contacts to be notified are contacts associated with a usage duration that is above a duration threshold.

5. The method according to claim 1, wherein a subscription identity identifies the subscription of the service for the subscriber, and
wherein the analysis of the data comprises creating a graph representing a connection between the subscription identity and the contact.

6. The method according to claim 5, wherein the determined one or more contacts to be notified are one or more contacts associated with values in the graph that are larger than a graph threshold.

7. The method according to claim 1, wherein a subscription identity identifies the subscription of the service for the subscriber, and
wherein the subscription identity is a Mobile Subscriber Integrated Services Digital Network Number, MSISDN, and is comprised in the notification to the one or more contacts.

8. The method according to claim 1, wherein the determined one or more contacts are notified via Short Message Service, SMS, and/or email and/or Interactive Voice Response, IVR.

9. The method according to claim 1, wherein a subscription identity identifies the subscription of the service for the subscriber, and
wherein the obtained data comprises at least one of:
identity of each contact, and/or
usage frequency for service usage between the subscriber identity and each contact, and/or
usage duration for each service usage between the subscriber identity and each contact.

10. The method according to claim 1, wherein the data is obtained from a database.

11. The method according to claim 1, wherein the network node is a Subscriber Deactivation Handler, SDH, and is comprised in a customer management system.

12. A network node adapted to:
detect that a subscriber's subscription to a service has been deactivated from a communications network;
obtain data related to usage of the service;
analyze the data to determine one or more contacts of the subscriber that should be notified about the deactivated subscription; and to
initiate one or more notifications to the determined one or more contacts about the deactivated subscription.

13. The network node according to claim 12, wherein the obtained data is associated with a time period.

14. The network node according to claim 12, wherein a subscription identity identifies the subscription of the service for the subscriber,
wherein the obtained data indicates a usage frequency to and/or from contacts, and
wherein the determined one or more contacts to be notified are contacts associated with a usage frequency that is above a frequency threshold.

15. The network node according to claim 12, wherein a subscription identity identifies the subscription of the service for the subscriber,
wherein the obtained data indicates a usage duration of service usage between the subscription identity and the contacts, and
wherein the determined one or more contacts to be notified are contacts associated with a usage duration that is above a duration threshold.

16. The network node according to claim 12, being adapted to create a graph representing a connection between the subscription identity and the contact.

17. The network node according to claim 16, wherein the one or more contacts to be notified are one or more contacts associated with values in the graph that are larger than a graph threshold.

18. (canceled)

19. (canceled)

20. The network node according to claim 12, wherein a subscription identity identifies the subscription of the service for the subscriber, and
wherein the obtained data comprises at least one of:
identity of each contact, and/or
usage frequency for service usage between the subscriber identity and each contact, and/or
usage duration for each service usage between the subscriber identity and each contact.

21. (canceled)

22. The network node according to claim 12, wherein the network node is a Subscriber Deactivation Handler, SDH, and is comprised in a Customer Management System.

23. A computer program comprising a non-transitory computer readable storage medium that stores instructions which, when executed on at least one processor, cause the at least one processor to carry out the method according to claim 1.

24. (canceled)
